(19) United States
(12) Patent Application Publication
(10) Pub. No.: US 2004/0254981 A1
(43) Pub. Date: Dec. 16, 2004

(54) Apparatus for and method of providing recording related information regarding disc

(75) Inventor: Ki-ju Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/865,952

(22) Filed: Jun. 14, 2004

(30) Foreign Application Priority Data
Jun. 14, 2003 (KR) 2003-38524

(51) Int. Cl. G06F 15/16

(52) U.S. Cl. 709/203

(57) ABSTRACT

An apparatus for and method of providing recording related information regarding a disc. The apparatus includes a disc drive that determines whether a disc inserted therein can be recorded to; and a processor that obtains information from the disc drive as to whether the disc drive can record to the disc, and displays the information regarding the disc if the disc drive cannot record to the disc.

### CROSS-REFERENCE TO RELATED APPLICATIONS

This application claims the priority of Korean Patent Application No. 2003-38524, filed on Jun. 14, 2003, in the Korean Intellectual Property Office, the disclosure of which is incorporated herein in its entirety by reference.

### BACKGROUND OF THE INVENTION

1. Field of the Invention

The present invention relates to an operation of recording to a disc, and more particularly, to an apparatus for, and method of, providing recording related information for a disc; and to provide various kinds of recording related information about the disc to a user when the disc can not be recorded on by a disc drive.

2. Description of the Related Art

With the introduction of storage media such as discs, that have a large memory capacity, it has become the standard for computers to have disc drives to access the discs. With the help of software that supports recording data stored in the computer, e.g., Nero™ or EZCD™, disc drives that enable a user to back-up data on a recordable disc have also become standard.

However, computer systems with recordable disc drives provide either no error messages or, only limited error messages to a user when a recordable disc drive tries to back-up data on a disc inserted therein.

As such, if the user tries to perform a data back-up on a disc that is not supported by the disc drive, and no error message is provided to the user, the user cannot determine whether data is being recorded to the disc. The user may then repeatedly try to back-up data on the disc, resulting in a loss of data or damage to the disc. Even if the computer system provides a short error message notifying the user that an inserted disc can not be recorded to, disc information from the message is so limited that the user may not take further steps to perform the data backup on the disc.

Accordingly, there is a need to provide a user with information as to whether a disc drive supports a disc inserted therein, and if the disc is not supported by the disc drive, to provide software to enable the disc drive to record to the disc.

### SUMMARY OF THE INVENTION

The present invention provides an apparatus for, and method of, providing recording related information regarding a disc.

Additional aspects and/or advantages of the invention will be set forth in part in the description which follows and, in part, will be obvious from the description, or may be learned by practice of the invention.

According to an aspect of the present invention, there is an apparatus that provides information regarding a disc, the apparatus comprising: a disc drive that determines whether a disc inserted therein can be recorded to; and a processor that obtains information from the disc drive, the information indicating whether the disc drive can record to the inserted disc, and displays the information regarding the disc if the disc drive cannot record to the disc.

Throughout the specification the words computer and processor are used interchangeably. While the term includes personal computers, it is not intended to be limited thereto, but is instead intended to broadly refer to any processor that is capable of performing the functions as recited in the claims. Examples of possible processors include: personal computers, PDAs, microprocessors, IC chips, pocket computers, audio CD controllers, stereo controllers, etc.

According to an aspect of the present invention, the information regarding the disc includes the type of disc, and manufacturer information for the disc.

According to an aspect of the present invention, the information regarding the disc includes website information indicating a website address where information related to the disc is available.

According to an aspect of the present invention, the information regarding the disc includes the contents of a website containing information related to the disc.

According to an aspect of the present invention, the disc drive and the computer communicate with each other according to an AT Attachment System Interface protocol.

According to another aspect of the present invention, there is an apparatus that provides information regarding a disc in a computer that is inserted in a disk drive, the apparatus comprising: a disc back-up supporter that stores a utility to enable a user to instruct that a disc be recorded; a disc information servicer that displays recording related information regarding the disc to a user; an information searcher that receives a request from the disc information servicer to search for the recording related information regarding the disc, and transmits a result of the search to the disc information servicer; and an interface unit that transmits an instruction generated by the disc back-up supporter to perform the disc recording or an instruction generated by the disc information servicer to search for the recording related information regarding the disc, and receives data output by the disc drive, according to a predetermined protocol.

According to an aspect of the present invention, the disc information servicer determines whether the disc drive supports the disc to be recorded to, and displays the recording related information regarding the disc to a user if the disc drive does not support the disc.

According to an aspect of the present invention, if the disc drive does not support the disc to be recorded to, the information searcher searches a server or website for the recoding related information regarding the disc and transmits a result to the disc information servicer, and the disc information servicer displays the result.

According to an aspect of the present invention, if the disc drive does not support the disc to be recorded to, the information searcher connects to a server or website and downloads contents from the server or website and transmits the contents to the disc information servicer, and the disc information servicer displays the contents.

According to an aspect of the present invention, if the disc drive does not support the disc to be recorded, the information searcher downloads software supporting recording of the disc from a server or website and the disc information servicer instructs the disc drive to install the software.

According to an aspect of the present invention, the interface unit communicates with the disc drive according to an AT Attachment System Interface protocol.

According to yet another aspect of the present invention, there is a method of providing information regarding a disc in a disc drive in a computer, the method comprising: determining whether the disc drive supports recording to a disc in the disc drive; and if the disc is not supported to be recorded to by the disc drive, displaying recording related information regarding the disc to a user.

According to an aspect of the present invention, displaying the recording related information regarding the disc, comprises: connecting to a website having information regarding the disc; downloading the contents of the website; and displaying the contents.

According to an aspect of the present invention, the method further comprises: connecting to a server via a network and downloading software which supports recording to the disc by the disc driver; and executing the software to enable the disc drive to record to the disc in the disc drive.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an apparatus that provides recording related information of a disc, according to an aspect of the present invention; and

FIG. 2 is a flowchart illustrating a method of providing recording related information regarding a disc, according to an aspect of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

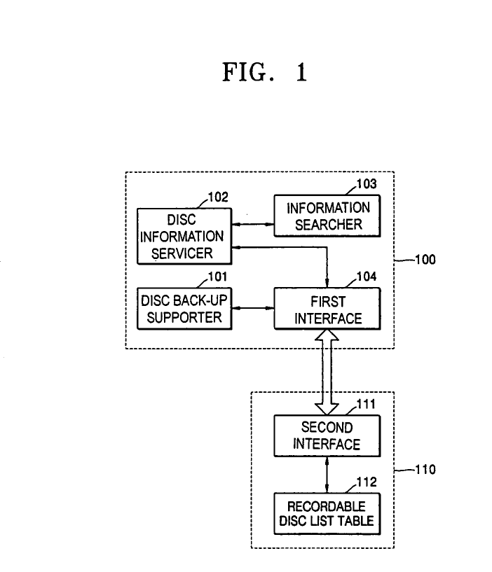

FIG. 1 is a block diagram of an apparatus that provides recording related information regarding a disc according to an aspect of the present invention. The apparatus includes a computer 100 and a disc drive 110.

The computer 100 includes a disc back-up supporter 101, a disc information servicer 102, an information searcher 103, and a first interface 104.

The disc back-up supporter 101 stores a utility program, such as, Nero™ or EZCD™, that allows a user to instruct the disc drive 110 to perform back-up, recording, and/or copying onto a disc inserted in the disc drive 110.

The disc information servicer 102 provides recording related information to the user. The recording related information is provided by determining whether the disc drive 110 supports the disc to be recorded to, and displaying information regarding the disc if the disc drive 110 does not support the disc to be recorded to.

The information searcher 103 connects to a server (not shown) via a network that provides information regarding the disc, such as the Internet, when a request to search for the information regarding the disc is received from the disc information servicer 102. Then, the information searcher 103 downloads the information regarding the disc from the server and provides the information to the disc information servicer 102. The information searcher 103 connects to the server using basic disc information given by the disc, such as a disc ID. The information downloaded from the server includes not only the type of the disc or manufacturer information, but names of software programs or the software itself that support the disc to be recorded to by the disc drive 110.

The first interface 104 transmits instructions generated by the disc back-up supporter 101 or the disc information servicer 102, or receives data from the disc drive 110 according to a predetermined protocol. Generally, the protocol employed by the first interface 104 and a second interface 111 between the computer 100 and the disc drive 110 is an AT attachment system interface (ATAPI) protocol. One of the instructions transmitted by the first interface 104 may be to check whether the disc drive 110 can support the disc to be recorded to. Another instruction may be to send the disc drive 110 the software downloaded from the server that supports recording to the disc by the disc drive 110.

The disc drive 110 includes the second interface 111 and a recordable disc list table 112.

The second interface 111 receives and interprets the instructions from the first interface 104 of the computer 100 according to the same protocol used by the first interface 104.

The recordable disc list table 112 is a write strategy table (WST) including a list of discs supported by the disc drive 110, in other words, a list of discs that the disc drive 110 can record to.

The operations of the apparatus of FIG. 1 will now be described.

To back-up/record data on a disc, a user inserts the disc into the disc drive 110. Then, the user instructs the disc drive 110 to perform the back-up/recording function using the computer 100 with the utility program provided by the disc back-up supporter 101.

At this time, the disc information servicer 102 generates an instruction to determine whether the disc drive 110 supports the disc to be recorded, and sends the instruction to the disc drive 110 via the first and second interfaces units 104 and 111.

A controller (not shown) of the disc drive 110 may search the recordable disc list table 112 to determine whether the disc in the disc drive 110 is listed in the recordable disc list table 112, and send a result of the determination to the disc information servicer 102 of the computer 100 via the second and first interfaces 111 and 104. Basic disc information that the disc drive 110 reads from the disc, such as, disk ID, manufacturer of the disc, etc., may also be sent with the result of determination.

Upon receiving the result of determination with the basic disc information, if the result of determination indicates that the disc is not supported by the disc drive 110, the information servicer 102 forwards the basic disc information to the information searcher 103.

The information searcher 103 receives the basic disc information from the information servicer 102 and connects to and searches a related server on a network, which has information regarding the corresponding disc, based on the basic disc information. The information searcher 103 may return the information regarding the disc or the complete content downloaded from the server to the disc information searcher 102.

The disc information servicer 102 displays the information received from the information searcher 103.

Meanwhile, the information searcher 103 may download software that supports the disc to be recorded by the disc drive 110 from the server. The software downloaded by the information searcher 103 is stored in a memory (not shown) of the disc drive 110 via the disc information servicer 102, and the first and second interfaces 104 and 111, and executed by the controller of the disc drive 110. After the software is installed in the disc drive 110, the disc information is added to the recordable disc list table 112. Accordingly, if the same kind of disc is later inserted into the disc drive 110, recording to the disc is enabled by the disc drive 110. However, whether to download or install the software may depend on the user's confirmation.

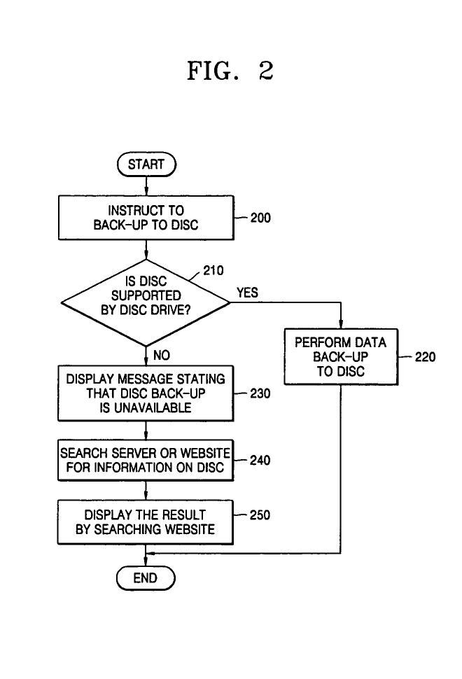

FIG. 2 is a flowchart illustrating a method of providing the recording related information of the disc according to an aspect of the present invention which will be described in conjunction with FIG. 1.

First, when a disc is inserted in the disc drive 110, a user instructs the computer 100 to perform the disc back-up or disc recording in operation 200.

The disc drive 110 notifies the computer 100 whether the back-up or recording to the disc is supported by the disc drive 110 in operation 210.

If the recording to the disc is supported by the disc drive 110, the computer makes the disc drive 110 perform the back-up or recording to the disc in operation 220.

On the other hand, if the recording the disc is not supported by the disc drive 110, the computer displays a message to a user indicating that the back-up or recording to the disc is not supported by the disc drive 110 in operation 230.

In operation 240, the computer 100 searches a web site or server via a network, e.g., the Internet, for recording related information regarding the disc, based on basic disc information read from the disc. Searching the web site or server for the recording related information regarding the disc can be automatically performed by the computer 100 without a user's instruction.

In operation 250, the recording related information of the disc searched for on the wet site or server is displayed by the computer 100, the recording related information of the disc being the complete content that the web site or server has or a portion of the information related to recording on the disc. When displaying the recording related information regarding the disc, the computer 100 may also download software to enable the disc drive 110 to support the disc to be recorded from the web site or server. The downloaded software can be installed in the computer 100, and thereby enable any disc of the same type as the disc in the disc drive 110 to be recorded to by the disc drive 110 in the future. Before downloading the software, the user may confirm whether it should be downloaded.

According to various aspects of the present invention, when recording to the disc, a user can be informed by the computer whether recording to the disc is supported by the disc drive. Even if the disc is not supported by the disc drive, the user can enable the disc drive to record to the disc by automatically or selectively installing software to support the disc recording, thereby easily managing disc recording.

Although the present invention has been shown and described it will be appreciated by those skilled in the art that various changes may be made to the described embodiments without departing from the principles and spirit of the invention, the scope of which is defined by the claims and their equivalents.

What is claimed is:

1. An apparatus that provides information regarding a disc, comprising:
a disc drive that determines whether the disc inserted therein can be recorded to; and
a processor that obtains information from the disc drive as to whether the disc drive can record to the disc, and displays the information regarding the disc if the disc drive cannot record to the disc.

2. The apparatus of claim 1, wherein the information regarding the disc includes a type of the disc, and manufacturer information for the disc.

3. The apparatus of claim 1, wherein the information regarding the disc includes website information, the website having information related to the disc.

4. The apparatus of claim 1, wherein the information regarding the disc includes contents of a website having information related to the disc.

5. The apparatus of claim 1, wherein the disc drive and the processor communicate with each other according to an AT Attachment System Interface protocol.

6. An apparatus that provides information regarding a disc in a processor combined with a disc drive, the apparatus comprising:
a disc back-up supporter that stores a utility for a user to instruct the disc to be recorded;
a disc information servicer that displays record related information regarding the disc to a user;
an information searcher that receives a request from the disc information servicer to search for the record related information regarding the disc, and transmits a result of the search to the disc information servicer; and
an interface that transmits an instruction generated by the disc back-up support to perform the disc recording or an instruction generated by the disc information servicer to search for the recording related information regarding the disc, and receives data output by the disc drive to the disc drive, according to a predetermined protocol.

7. The apparatus of claim 6, wherein the disc information servicer determines whether the disc drive supports the disc to be recorded to, and displays the record related information regarding the disc to a user if the disc drive does not support the disc.

8. The apparatus of claim 7, wherein if the disc drive does not support the disc to be recorded to, the information searcher searches a server or a website for the recording related information regarding the disc and transmits a result to the disc information servicer, and the disc information servicer displays the result.

9. The apparatus of claim 7, wherein if the disc drive does not support the disc to be recorded to, the information searcher connects to a server or website and downloads contents of the server of website and transmits the contents to the disc information servicer, and the disc information servicer displays the contents.

10. The apparatus of claim 6, wherein, if the disc drive does not support the disc to be recorded, the information searcher downloads software supporting recording of the disc from a server of website and the disc information servicer instructs the disc drive to install the software.

11. The apparatus of claim 6, wherein the interface unit communicates with the disc drive according to an AT Attachment System Interface protocol.

12. A method of providing information regarding a disc in a processor combined with a disc drive, the method comprising:
determining whether the disc drive supports recording to a disc in the disc drive; and
displaying recording related information regarding the disc to a user if the disc is not supported to be recorded to by the disc drive.

13. The method of claim 12, wherein the displaying the recording related information regarding the disc, comprises:
connecting to a website having information regarding the disc;
downloading contents from the website; and
displaying the contents.

14. The method of claim 12 further comprising:
connecting to a server via a network and downloading software which supports recording to the disc by the disc driver from the server; and
executing the software to enable the disc drive to record to the disc in the disc drive.

15. An apparatus to record data on a disc, the apparatus comprising:
a disc drive in which the disc is removably provided, the disc drive to record data onto the disc; and
a processor, connected with the disc drive, to determine if the disc drive is able to record data onto the disc;
wherein, if the disc drive is not able to record the data on the disc, the processor accesses a network and downloads software to enable the disc drive to record the data on the disc.

16. The apparatus of claim 15, wherein the processor automatically executes the software to enable the disc drive to record the data on the disc.

17. The apparatus of claim 15, wherein the processor requires a user input before accessing the network.

18. The apparatus of claim 15, wherein the network is the internet.

19. The apparatus of claim 18, wherein the processor accesses a predetermined website.

20. The apparatus of claim 15, wherein the disc is an optical disc.

21. The apparatus of claim 15, wherein when the disc drive is not able to record the data on the disc, the processor provides a signal to indicate that the disc drive is not able to record the data on the disc.

22. The apparatus of claim 21, further comprising a display to display that the disc drive is not able to record the data on the disc to the user according to the signal provided by the processor.

23. The apparatus of claim 15, wherein the disc drive reads disc information from the disc and transmits the read disc information to the processor.

24. The apparatus of claim 23, wherein the disc information includes at least one of a disc ID or manufacturer information.

25. The apparatus of claim 15, wherein the disc drive and the processor transfer information according to an AT Attachment System Interface protocol.

26. The apparatus of claim 15, wherein the processor comprises a first interface to transmit data to and receive data from the disc drive, and the disc drive comprises a second interface to transmit data to and receive data from the processor.

27. The method of claim 15, wherein the processor is a personal computer.

28. The method of claim 15, wherein the processor is an integrated circuit chip.

29. The method of claim 15, wherein the processor is a microprocessor.

30. A method of enabling a disc drive to record data onto a disc, the method comprising:
determining if the disc drive is able to record the data onto the disc inserted into the disc drive; and
if the disc drive is not able to record the data onto the disc:
reading disc information from the disc;
automatically connecting to a network;
automatically searching the network for software to enable the disc drive to record data onto the disc; and
automatically executing the software to enable the disc drive to record data onto the disc.

31. The method of claim 30, wherein the network is the internet.

32. The method of claim 31, wherein a predetermined website is accessed.

33. The method of claim 30, wherein the disc is an optical disc.

34. The method of claim 30, wherein the disc information includes manufacturer information.
